(19) United States
(12) Patent Application Publication
(10) Pub. No.: US 2010/0093312 A1
(43) Pub. Date: Apr. 15, 2010

(54) METHOD OF PROVIDING MULTICAST-BASED PUSH-TO-EVERYTHING SERVICE USING MBMS SERVER

(75) Inventors: Hyun-suk ROH, Daejeon-Si (KR); Jung-mo MOON, Daejeon-Si (KR); Sang-ho LEE, Daejeon-Si (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/578,110

(22) Filed: Oct. 13, 2009

(30) Foreign Application Priority Data
Oct. 13, 2008 (KR) 10-2008-0100019

(51) Int. Cl. H04M 1/66; H04W 4/00

(52) U.S. Cl. 455/411; 455/466

(57) ABSTRACT

Provided is a multicast-based push-to-everything (PTx) service. The method of providing a PTx service using a multimedia broadcast/multicast service (MBMS) server includes: generating a PTx service session at the request of a user equipment (UE); subscribing UEs, which desire to subscribe to the generated PTx service session, to the generated PTx service session; providing a PTx service to the UEs, which subscribed to the PTX service session, in a multicast manner; and unsubscribing a UE from the PTx service session at the request of the UE. Therefore, a multicast-based PTx service can be provided in a long-term evolution advanced (LTE-Adv) network.

### CROSS REFERENCE TO RELATED APPLICATION

This application claims the benefit under 35 U.S.C. §119(a) of Korean Patent Application No. 10-2008-100019, filed on Oct. 13, 2008, the disclosure of which is incorporated by reference in its entirety for all purposes.

### BACKGROUND

1. Field

The following description relates to network technology, and more particularly, to a push-to-everything (PTx) service in a network system.

2. Description of the Related Art

Since the standardization of a wideband code division multiple access (WCDMA) third generation mobile communication system, a third generation partnership project (3GPP) has been upgrading the third generation mobile communication system by continuously adding technologies, such as high-speed downlink packet access (HSDPA), multimedia broadcast/multicast service (MBMS), and high-speed uplink packet access (HSUPA), to the third generation mobile communication system. In addition, since the year 2005, the 3GPP has been standardizing a long-term entity (LTE) which is based on an orthogonal frequency-division multiple access (OFDMA)/single carrier-frequency division multiple access (SC-FDMA) transmission scheme. As requirements for international mobile telecommunications (IMT)-Advanced and the schedule for proposing IMT-Advanced are discussed in International Telecommunications Union-Radio Sector (ITU-R), Working Party 5D (WP5D), the 3GPP has named a candidate technology, which is an advanced version of LTE and is to be proposed in IMT-Advanced, as ‘LTE-Advanced’ and begun to standardize LTE-Advanced.

A push-to-x (PTx) service has been developed to enable a group of mobile terminal users to communicate with each other over a mobile communication network. A PTx service is a semi-dual communication service in which a client given an option/permission to transmit media data (including voice and video data) sends the media data and one or more other clients, which have established a session with the client through a server, receive the media data. Examples of a PTx service include a push-to-talk-over-cellular (PoC) service for providing a call service by sending voice data, a push-to-view (PTV) service for sending video data, and a push-to-data (PTD) service for sending various data.

A PTx service is implemented in a conventional general packet radio service (GPRS) network or a packet data serving node (PDSN). In addition, a PTx service is provided in a unicast manner. In some documents, it is written that a PTx service is a multicast-based service, but a method of providing a multicast-based PTx service is not provided in these documents. In fact, repeated provision of a unicast-based PTx service is written as provision of a multicast-based PTx service in these documents, which, however, cannot be understood as such.

### SUMMARY

Accordingly, it is an objective of the present invention to provide a push-to-everything (PTx) service in a third generation partnership project long-term entity (3GPP LTE)-advanced network by defining a signal procedure for the PTx service in the 3GPP LTE-advanced network. In particular, it is an objective of the present invention to provide a multicast-based PTx service.

In one general aspect, there is provided a method of providing a multicast-based PTx service using a multimedia broadcast/multicast service (MBMS) server. The method includes: generating a PTx service session at the request of a user equipment (UE); subscribing UEs, which desire to subscribe to the generated PTx service session, to the generated PTx service session; providing a PTx service to the UEs, which subscribed to the PTX service session, in a multicast manner; and unsubscribing a UE from the PTx service session at the request of the UE.

The subscribing of the UEs includes: receiving an authorization request message from a gateway which received a subscription request message from a UE; verifying whether the UE which sent the subscription request message is authorized to subscribe to the PTx service session, in response to the received authorization request message; sending an authorization response message to the gateway after verifying whether the UE which sent the subscription request message is authorized to subscribe to the PTx service session; and generating context for the UE at the request of the gateway after each of the UE, which had been verified to be authorized to subscribe to the PTx service session, and the gateway generated the context for the UE.

The providing of the PTx service includes: receiving service data from a UE; and multicasting the received service data to the other UEs.

The unsubscribing of the UE from the PTx service session includes: receiving a leave indication message from a gateway which received an unsubscription request message from the UE; verifying whether the UE is authorized to unsubscribe from the PTx service session; issuing a command to the gateway to delete context for the UE after verifying that the UE is authorized to unsubscribe from the PTx service session; receiving a deactivation request message from the gateway which deleted the context for the UE in response to the command; and deleting the context for the UE in response to the received deactivation request message and sending a deactivation confirmation message to the gateway.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating the structure of a long-term evolution advanced (LTE-Adv) network;

FIG. 2 is a flowchart illustrating a procedure for generating a push-to-view (PTV) service;

FIG. 3 is a flowchart illustrating a procedure for subscribing to a PTV service session;

FIG. 4 is a flowchart illustrating a procedure for unsubscribing from a PTV service session;

FIG. 5 is a flowchart illustrating a procedure for registering a PTV service in a network;

FIG. 6 is a flowchart illustrating a procedure for starting a PTV service session; and

FIG. 7 is a flowchart illustrating a procedure for ending a PTV service session.

Elements, features, and structures are denoted by the same reference numerals throughout the drawings and the detailed description, and the size and proportions of some elements may be exaggerated in the drawings for clarity and convenience.

### DETAILED DESCRIPTION

The invention is described more fully hereinafter with reference to the accompanying drawings, in which exemplary embodiments of the invention are shown. Exemplary embodiments of the present invention will now be described in detail so that they can be readily understood and applied by those skilled in the art.

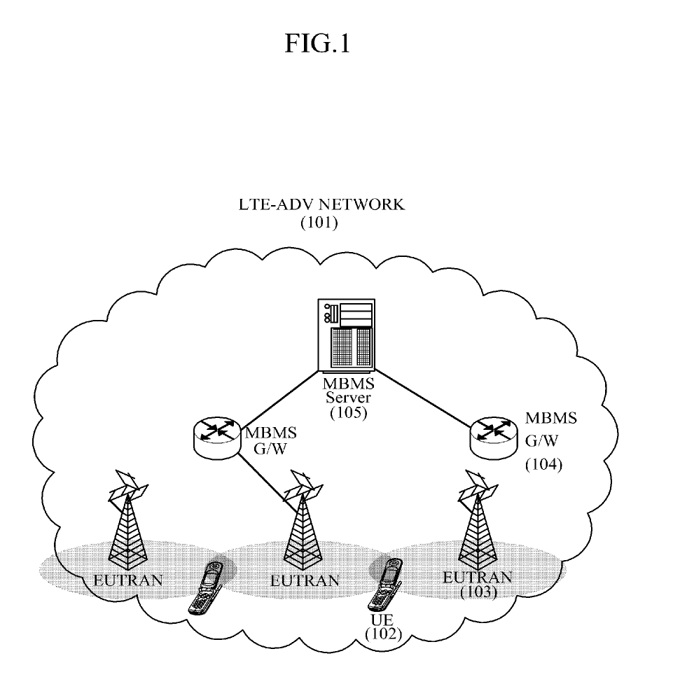

FIG. 1 is a diagram illustrating the structure of a long-term evolution advanced (LTE-Adv) network 101. Referring to FIG. 1, the LTE-Adv network 101 consists of one or more user equipments (UEs) 102 which are subscriber terminals, one or more evolved universal terrestrial radio access network (EUTRANs) 103 which function as base stations, one or more multimedia broadcast/multicast service gateways (MBMS G/Ws) 104 which perform a packet access routing function and a local mobility function, and an MBMS server 105 which performs MBMS control and data transmission. The present invention defines a specific signal procedure for providing a multicast-based push-to-everything (PTx) service in the LTE-Adv network 101.

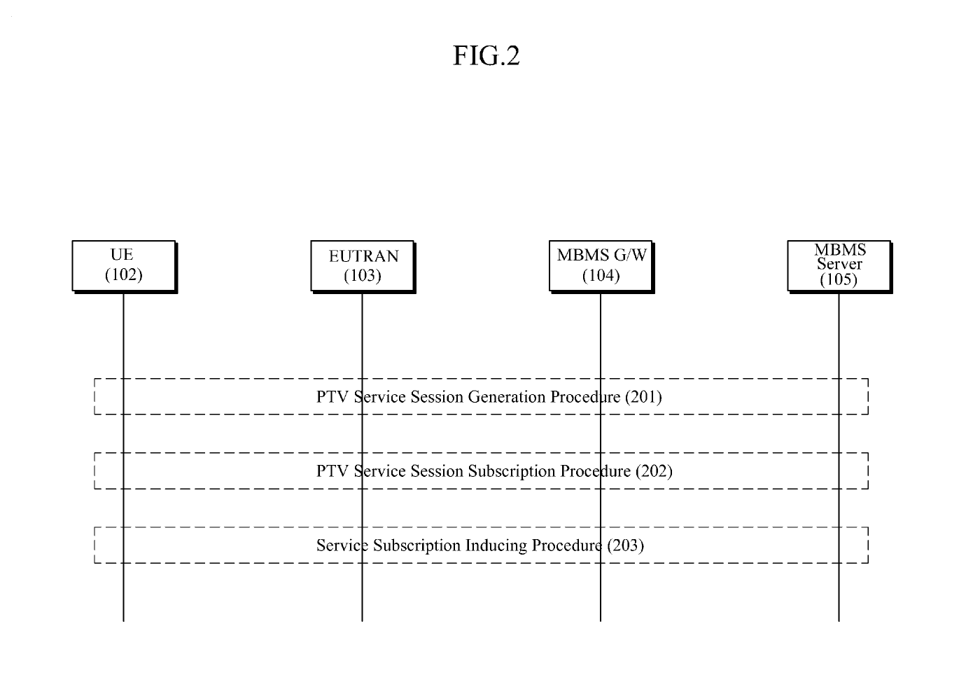

FIG. 2 is a flowchart illustrating a procedure for generating a push-to-view (PTV) service.

Referring to FIG. 2, a user who desires to generate a PTV service issues a command to initiate a procedure for generating a PTV service by manipulating a UE 102. Accordingly, the UE 102 generates a PTV service session by exchanging signals with an MBMS server 105 via a EUTRAN 103 and an MBMS G/W 104 (operation 201). For example, the UE 102 generates a PTV service session through a web-based hypertext transfer protocol (HTTP) procedure. In the PTV service session generation procedure, the UE 102 adds UE information (e.g., information about telephone numbers) of other users, who are desired by the user to participate in a PTV service session, to a PTV service session generation request message and sends the PTV service session generation request message to the MBMS server 105.

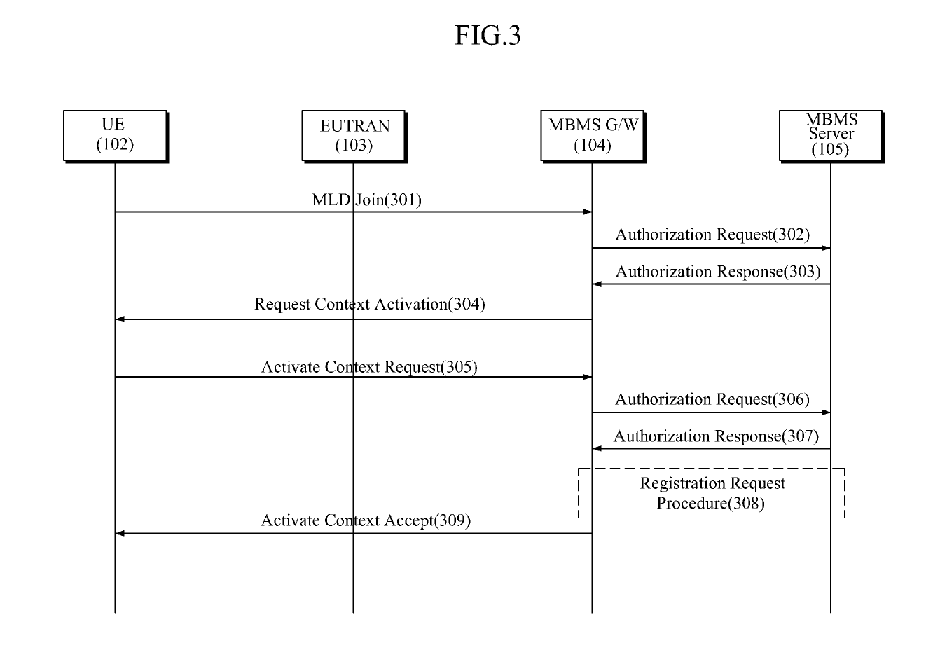

Once generating a PTV service session, the UE 102 performs a procedure for subscribing to the generated PTV service session (operation 202). The procedure for subscribing to the generated PTV service session will be described later with reference to FIG. 3. The MBMS server 105 checks the UE information of the prospective participants included in the PTV service session generation request message, which was received from the UE 102 in the PTV service session generation procedure, and sends a message for inducing the prospective participants to subscribe to the PTV service session (operation 203). In an exemplary embodiment, the MBMS server 105 may send a short message service (SMS) message to UEs of the prospective participants and induce the prospective participants to subscribe to the PTV service session.

FIG. 3 is a flowchart illustrating a procedure for subscribing to a PTV service session. The procedure illustrated in FIG. 3 is performed by a user, who generated a PTV service session or was induced to subscribe to the generated PTV service, to subscribe to the generated PTV service.

Referring to FIG. 3, a UE 102 sends to an MBMS G/W 104 a message for informing the MBMS G/W 104 that the UE 102 desires to subscribe to a PTV service session (operation 301). For example, the UE 102 sends a multicast listener discovery (MLD)_join message, which is based on an MLD standard, to the MBMS G/W 104. Accordingly, the MBMS G/W 104 receives the MLD_join message and sends an authorization request message to an MBMS server 105 in order to verify whether the UE 102 is authorized to subscribe to the PTV service session (operation 302).

The MBMS server 105 receives the authorization request message from the MBMS G/W 104 and verifies whether the UE 102 is authorized to subscribe to the PTV service session. That is, the MBMS server 105 verifies whether the UE 102 is authorized to receive a PTV service. For example, the MBMS server 105 may identify whether identification information of the UE 102 included in the MLD_join message matches identification information of the UE 102, which requested generation of a PTV service session, or identification information of a UE of a prospective participant.

After verifying whether the UE 102 is authorized to subscribe to the PTV service session, the MBMS server 105 sends an authorization response message to the MBMS G/W 104 (operation 303). When verifying that the UE 102 is authorized to subscribe to the PTV service session, the MBMS server 105 includes an access point name (APN) value in the authorization response message and sends the authorization response message accordingly, so that and the UE 102, a EUTRAN 103 (i.e., a base station), and the MBMS G/W 104 can sequentially generate UE context. Here, an APN may be an address of the MBMS G/W 104. Since various gateways exist in a real service, an APN is used to indicate a gateway that will provide an MBMS. In addition to the APN value, UE profile information may be added to the authorization response message in order for generation of UE context.

The MBMS G/W 104 receives the authorization response message from the MBMS server 105 and identifies whether it has been verified that the UE 102 is authorized to subscribe to the PTV service session. When it has been verified that the UE 102 is authorized to subscribe to the PTV service session, the MBMS G/W 104 sends a request context activation message to the UE 102 (operation 304). Here, the MBMS G/W 104 includes the UE profile information, which was received from the MBMS server 105 and is needed to generate context, in the request context activation message.

The UE 102 receives the request context activation message from the MBMS G/W 104 and generates its context using the UE profile information included in the received request context activation message. After generating its context, the UE 102 sends an activate context request message to the MBMS G/W 104 (operation 305). The MBMS G/W 104 receives the activate context request message from the UE 102 and generates context for the UE 102 accordingly. Although omitted here, the EUTRAN 103 generates the context for the UE 102 before the MBMS G/W 104. Thus, a packet switching path is established between the UE 102 and the MBMS G/W 104.

After generating the context for the UE 102, the MBMS G/W 104 sends an authorization request message to the MBMS server 105 (operation 306). Accordingly, the MBMS server 105 verifies again whether the UE 102 is authorized to subscribe to the PTV service session. When verifying that the UE 102 is authorized to subscribe to the PTV service session, the MBMS server 105 generates the context for the UE 102. Then, the MBMS server 105 sends an authorization response message to the MBMS G/W 104 (operation 307). When no temporary multicast group identifier (TMGI) has been allocated to the UE 102, the MBMS server 105 generates a TMGI, includes the generated TMGI in the authorization response message, and sends the authorization response message accordingly.

The MBMS G/W 104 receives the authorization response message from the MBMS server 105 and sends an activate context accept message to the UE 102 to inform the UE 102 that the context generation procedure has been successfully performed (operation 309). If the UE 102 is the first UE to subscribe to the PTV service session, the MBMS server 105 performs an MBMS registration procedure for the UE 102 (operation 308).

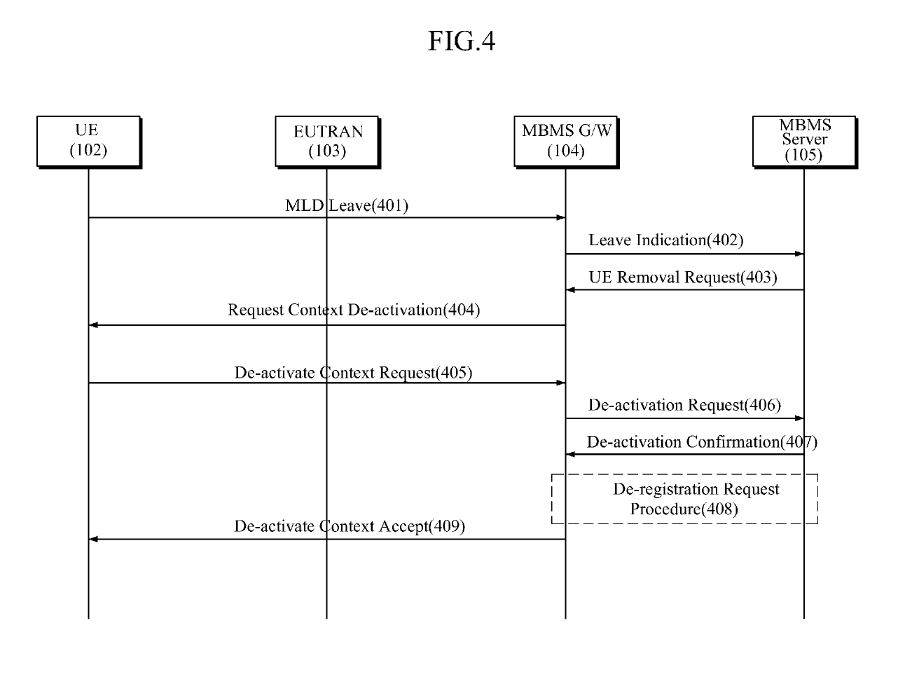

FIG. 4 is a flowchart illustrating a procedure for unsubscribing from a PTV service session. The procedure illustrated in FIG. 4 is performed by a UE, which is subscribed to a PTV service session, to unsubscribe from the PTV service session.

Referring to FIG. 4, a UE 102 sends to an MBMS G/W 104 a message for informing the MBMS G/W 104 that the UE 102 desires to unsubscribe from a PTV service session (operation 401). For example, the UE 102 sends an MLD_leave message, which is based on the MLD standard, to the MBMS G/W 104 (operation 402). Accordingly, the MBMS G/W 104 receives the MLD_leave message from the UE 102 and sends a leave indication message to an MBMS server 105 to inform the MBMS server 105 that the UE 102 has requested unsubscription from the PTV service session.

The MBMS server 105 receives the leave indication message and verifies whether the UE 102 is authorized to unsubscribe from the PTV service session. Here, the MBMS server 105 may verify whether the UE 102 is authorized to unsubscribe from the PTV service session in the same way that it verified whether the UE 102 is authorized to subscribe to the PTV service session. Once verifying that the UE 102 is authorized to unsubscribe from the PTV service session, the MBMS server 105 sends a UE removal request message to the MBMS G/W 104 in order to stop providing a PTV service to the UE 102 (operation 403). The MBMS G/W 104 receives the UE removal request message from the MBMS server 105 and sends a request context deactivation message to the UE 102 (operation 404).

The UE 102 receives the request context deactivation message from the MBMS G/W 104 and deletes corresponding service context information. Then, the UE 102 sends a deactivate context request message to the MBMS G/W 104 (operation 405). The MBMS G/W 104, which receives the deactivate context request message, deletes context information about the UE 102 and sends a deactivation request message to the MBMS server 105 (operation 406). The MBMS server 105 receives the deactivation request message from the MBMS G/W 104, deletes context for the UE 102 which it has been managing, sends a deactivation confirmation message to the MBMS G/W 104 so as to inform the MBMS G/W 104 that the context for the UE 102 has been deleted (operation 407).

The MBMS G/W 104 receives the deactivation confirmation message from the MBMS server 105 and sends a deactivate context accept message to the UE 102 so as to inform the UE 102 that the context for the UE 102 has been successfully deleted (operation 409). If the UE 102 is the last UE to unsubscribe from the PTV service session, the MBMS server 105 performs an MBMS registration cancellation procedure when deleting the context for the UE 102 (operation 408).

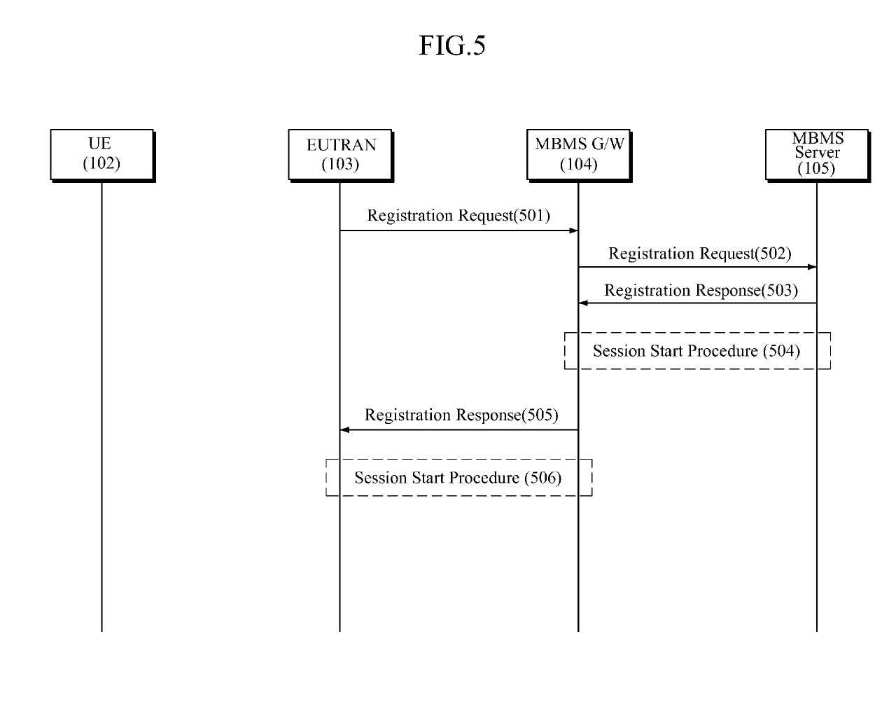

FIG. 5 is a flowchart illustrating a procedure for registering a PTV service in a network.

Referring to FIG. 5, a EUTRAN 103 sends a registration request message to an MBMS G/W 104 when recognizing that a UE 102 is interested in an MBMS (operation 501). In the case of service reservation, for example, a user who requests generation of a service session also requests a service reservation time when requesting generation of the service session. If a request for generation of a service session is made at 4:30 p.m. and if a service reservation time is 5:00 p.m., the MBMS G/W 104 may recognize that the UE 102 is interested in the MBMS when the time reaches 5:00 p.m. The MBMS G/W 104 manages information about service reservation times and compares the managed information with current time information to determine whether the UE 102 is interested in the MBMS.

The MBMS G/W 104 receives the registration request message from the EUTRAN 103 and generates bearer context. Then, the MBMS G/W 104 sends a registration request message to an MBMS server 105 (operation 502). The MBMS server 105, which receives the registration request message from the MBMS G/W 104, generates bearer context and sends a registration response message to the MBMS G/W 104 (operation 503). The MBMS G/W 104 receives the registration response message from the MBMS server 105 and sends a registration response message to the EUTRAN 103 (operation 505). In each registration response procedure (operation 503 or 505), when bearer context is active, a session start procedure is performed (operation 504 or 506).

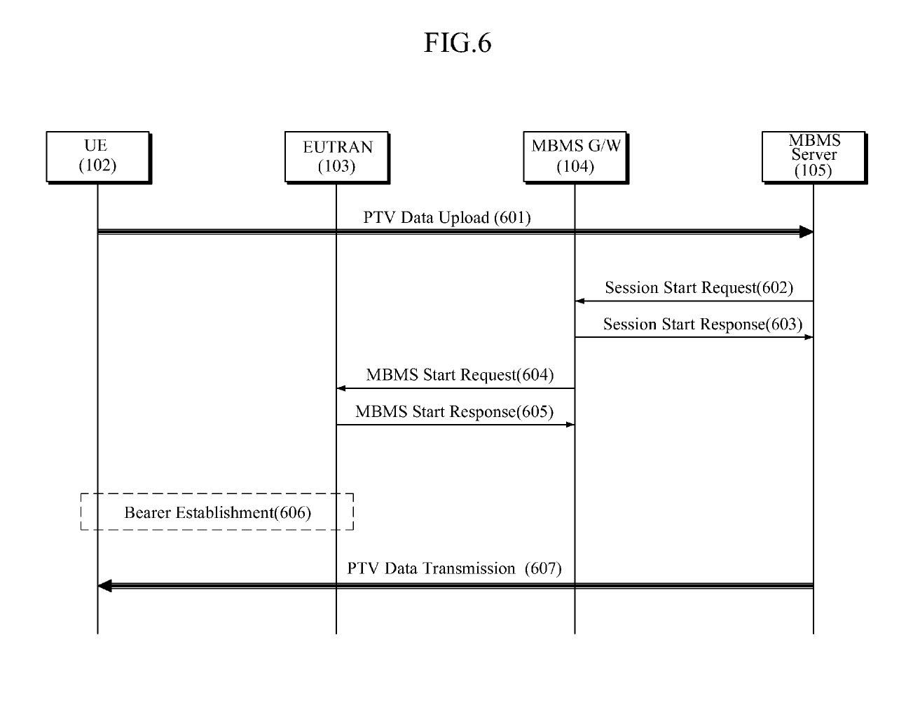

FIG. 6 is a flowchart illustrating a procedure for starting a PTV service session. A PTV service session starts from the moment when a user presses a Call button and continues until the user presses an End button. The Call button and the End button are only an example, and a method of starting and ending a service session is not limited to this example. When a UE sends PTV service data, if another UE attempts to send PTV service data, the latter data is stored in an MBMS server until a session of the former UE ends and is sent as soon as the service session of the UE ends.

Referring to FIG. 6, when a user having PTV data to send presses a Call button, a UE 102 uploads the PTV data to an MBMS server 105 (operation 601). Then, the MBMS server 105 multicasts the PTV data to other UEs (operation 607). In FIG. 6, the PTV data is sent to the UE 102 which sent the PTV data to the MBMS server 105. Unlike the illustration in FIG. 6, however, the PTV data is actually multicast to other UEs excluding the UE 102. Here, if a session start procedure has not been performed between the MBMS server 105 and other UEs, it is performed.

Specifically, the MBMS server 105 stores the PTV data uploaded in operation 601 while sending a session start request message to an MBMS G/W 104 to inform the MBMS G/W 104 that a service session will start soon (operation 602). The MBMS G/W 104 stores received session information and sends a session start response message to the MBMS server 105 (operation 603). In addition, the MBMS G/W 104 sends an MGBMS start request message including the session information to a EUTRAN 104 (operation 604). Accordingly, the EUTRAN 103 stores the received session information in its local storage and sends an MBMS start response message to the MBMS G/W 104 (operation 605). Then, the EUTRAN 103 establishes a bearer for necessary radio resources (operation 606). Later, the PTV data is sent through the established bearer (operation 607).

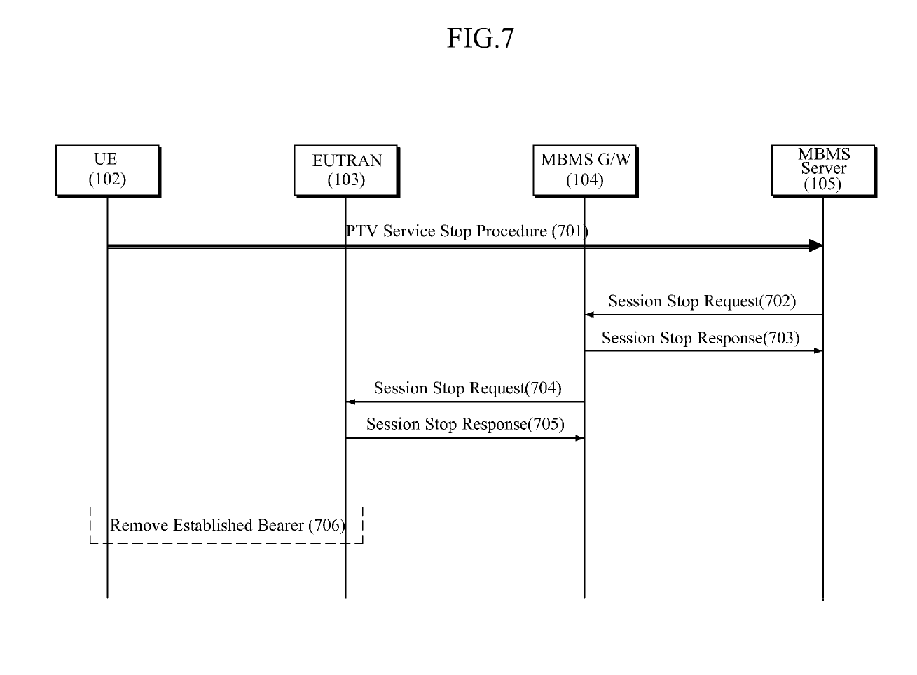

FIG. 7 is a flowchart illustrating a procedure for ending a PTV service session. The procedure for ending a PTV service session ends when an End button is pressed. As mentioned above, the End button is only an example, and a method of ending a service session is not limited to this example.

Referring to FIG. 7, when the End button is pressed, a UE 102 sends a message for ending a PTV service session to an MBMS server 105 (operation 701). When receiving the message, the MBMS server 105 deletes relevant information and sends a session stop request message to an MBMS G/W 104 so as to request the MBMS G/W 104 to delete relevant information about the UE 102 (operation 702). Accordingly, the MBMS G/W 104 deletes information related to the PTV service session and sends a session stop response message to the MBMS server 105 (operation 703). In addition, the MBMS G/W 104 sends a session stop request message to a EUTRAN 103 and thus requests the EUTRAN 103 to delete relevant information in order for the stoppage of the PTV service session (operation 704). Accordingly, the EUTRAN 103 deletes information related to the PTV service session and sends a session stop response message to the MBMS G/W 104 (operation 705). In addition, a bearer established between the UE 102 and the EUTRAN 103 is removed (operation 706).

The present invention has been described above based on a PTV service. However, the present invention is not limited to the PTV service and may also apply to other PTx services.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of providing a multicast-based push-to-everything (PTx) service using a multimedia broadcast/multicast service (MBMS) server, the method comprising:
generating a PTx service session at the request of a user equipment (UE);
subscribing UEs, which desire to subscribe to the generated PTx service session, to the generated PTx service session;
providing a PTx service to the UEs, which subscribed to the PTX service session, in a multicast manner; and
unsubscribing a UE from the PTx service session at the request of the UE.

2. The method of claim 1, wherein the subscribing of the UEs comprises:
receiving an authorization request message from a gateway which received a subscription request message from a UE;
verifying whether the UE which sent the subscription request message is authorized to subscribe to the PTx service session, in response to the received authorization request message;
sending an authorization response message to the gateway after verifying whether the UE which sent the subscription request message is authorized to subscribe to the PTx service session; and
generating context for the UE at the request of the gateway after each of the UE, which had been verified to be authorized to subscribe to the PTx service session, and the gateway generated the context for the UE.

3. The method of claim 2, wherein the subscribing of the UEs further comprises registering the UEs in the MBMS server after the generating of the context for the UE.

4. The method of claim 1, further comprising registering the UEs in the MBMS server between the subscribing of the UEs and the providing of the PTx service.

5. The method of claim 4, wherein the registering the UEs in the MBMS server comprises performing a session start procedure with a base station.

6. The method of claim 1, wherein the providing of the PTx service comprises:
receiving service data from a UE; and
multicasting the received service data to the other UEs.

7. The method of claim 6, wherein the providing of the PTx service further comprises sending a session start request message to a gateway, which is connected to the other UEs, and receiving a session start response message from the gateway.

8. The method of claim 7, wherein the providing of the PTx service further comprises:
receiving a service stop message from the UE after the multicasting of the received service data;
deleting information related to a service session in response to the service stop message and sending a session stop request message to a gateway; and
receiving a session stop response message from the gateway.

9. The method of claim 1, wherein the unsubscribing of the UE from the PTx service session comprises:
receiving a leave indication message from a gateway which received an unsubscription request message from the UE;
verifying whether the UE is authorized to unsubscribe from the PTx service session;
issuing a command to the gateway to delete context for the UE after verifying that the UE is authorized to unsubscribe from the PTx service session;
receiving a deactivation request message from the gateway which deleted the context for the UE in response to the command; and
deleting the context for the UE in response to the received deactivation request message and sending a deactivation confirmation message to the gateway.
